(19) United States
(12) Patent Application Publication
(10) Pub. No.: US 2023/0082295 A1
(43) Pub. Date: Mar. 16, 2023

(54) MEASUREMENT DEVICE, MEASUREMENT METHOD, AND COMPUTER-READABLE RECORDING MEDIUM STORING MEASUREMENT PROGRAM

(71) Applicant: FUJITSU LIMITED, Kawasaki-shi (JP)

(72) Inventors: KOSUKE YANAI, Kawasaki (JP); Shinichi Fujiyoshi, Fukuoka (JP); Yoshikatsu KOHARA, kitakyushu (JP); Etsuko YAMASHITA, Fukuoka (JP); Koichi Iida, Kobe (JP); Katsushi Sakai, Zama (JP)

(73) Assignee: FUJITSU LIMITED, Kawasaki-shi (JP)

(21) Appl. No.: 17/990,259

(22) Filed: Nov. 18, 2022

Related U.S. Application Data
(63) Continuation of application No. PCT/JP2020/021872, filed on Jun. 3, 2020.

(51) Int. Cl. G01S 17/26; G01S 7/4865; G01S 7/481

(52) U.S. Cl. CPC G01S 17/26; G01S 7/4865; G01S 7/4814

(57) ABSTRACT

A measurement device includes: a memory; and a processor coupled to the memory and configured to: generate a drive signal with a sine wave, according to a clock signal; control a reflection direction of output light of a light emitting device, by utilizing a resonance frequency, according to the drive signal; control a timing at which the drive signal is generated; and add or remove a pulse of a reference clock signal configured to generate the clock signal, according to a phase difference between a desired control signal and the control signal.

### CROSS-REFERENCE TO RELATED APPLICATION

This application is a continuation application of International Application PCT/JP2020/021872 filed on Jun. 3, 2020 and designated the U.S., the entire contents of which are incorporated herein by reference.

### FIELD

Embodiments discussed herein are related to a measurement device, a measurement method, and a measurement program.

### BACKGROUND

A technique that synchronizes a plurality of distance measurement devices including light emitting elements, micro electro mechanical systems (MEMS) mirrors, and light receiving elements has been disclosed.

Japanese Laid-open Patent Publication No. 2018-63228 and Japanese Laid-open Patent Publication No. 62-166172 are disclosed as related art.

### SUMMARY

According to an aspect of the embodiments, a measurement device includes: a memory; and a processor coupled to the memory and configured to: generate a drive signal with a sine wave, according to a clock signal; control a reflection direction of output light of a light emitting device, by utilizing a resonance frequency, according to the drive signal; control a timing at which the drive signal is generated; and add or remove a pulse of a reference clock signal configured to generate the clock signal, according to a phase difference between a desired control signal and the control signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an overall configuration of a measurement system according to an embodiment;

FIG. 2 is an explanatory diagram of a time-of-flight (TOF) technology;

FIG. 3A is a diagram illustrating a slave frame pulse;

FIG. 3B is a diagram illustrating a slave line pulse;

FIG. 3C is a diagram illustrating a vertical drive signal generated according to the timing of a frame pulse;

FIG. 3D is a diagram illustrating a horizontal drive signal generated according to the timing of a line pulse;

FIG. 4 is a diagram illustrating a relationship between an ineffective pixel area and an effective pixel area during one round trip in a vertical direction;

FIG. 5 is a block diagram illustrating details of a synchronization control unit;

FIG. 6 is a block diagram illustrating details of a phase comparison unit;

FIGS. 7A and 7B are diagrams illustrating details of clock control by the synchronization control unit;

FIG. 8 is a flowchart representing an example of the operation of the measurement system;

FIG. 9 is a flowchart representing an example of a synchronization process in step S23;

FIG. 10 is a diagram illustrating an application example of the measurement system; and

FIG. 11 is a diagram illustrating a hardware configuration.

### DESCRIPTION OF EMBODIMENTS

For example, in the above technique, a correction table is prepared for a correction target range, and position correction is performed by referring to the correction table based on a phase difference acquired in a measurement device. It is difficult to make adjustments at high resolution because dealing with ranges outside the correction range prepared in advance is not allowed. Meanwhile, when trying to achieve high-resolution adjustments, the contents of the correction table become enormous. Thus, a technique that detects an internal clock and a frequency offset of input data and inserts or removes an adjustment clock pulse has been disclosed (see Japanese Laid-open Patent Publication No. 62-166172, for example). However, since this technique is for correcting minute fluctuations caused by oscillator (OSC) deviation and the like, the phase difference will be finely adjusted. However, finely adjusting the phase difference impairs the followability between measurement devices. Meanwhile, when trying to broadly make adjustments at once, there are concerns about damage to the MEMS and the occurrence of undesired resonance.

In one aspect, an object of the present embodiments is to provide a measurement device, a measurement method, and a measurement program capable of easily synchronizing measurement devices with each other.

Hereinafter, embodiments will be described with reference to the drawings.

### Embodiments

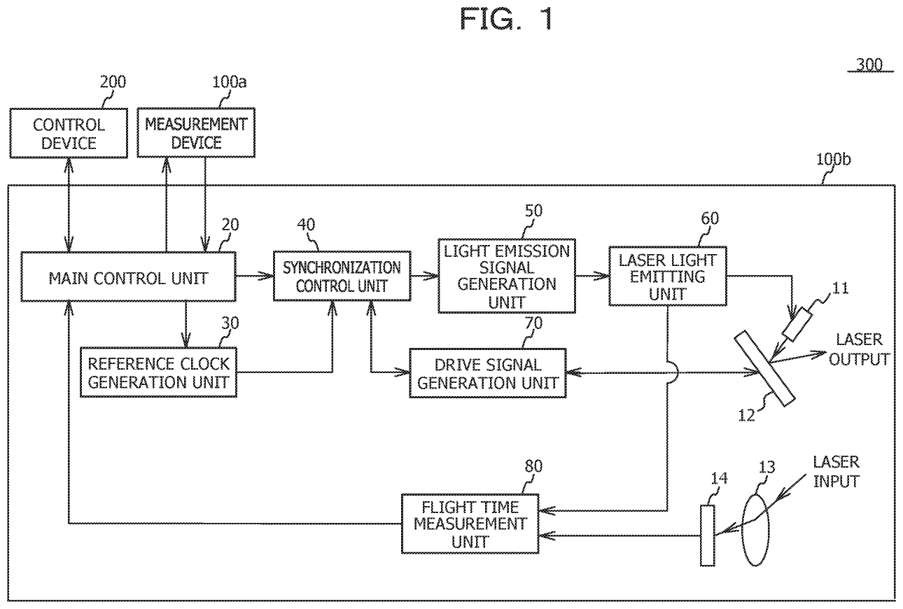

FIG. 1 is a schematic diagram illustrating an overall configuration of a measurement system 300 according to an embodiment. As illustrated in FIG. 1, the measurement system 300 includes a plurality of measurement devices 100a and 100b, a control device 200, and the like. The plurality of measurement devices 100a and 100b and the control device 200 are connected through a network by wire or wirelessly. In the present embodiment, the measurement device 100a functions as a master and the measurement device 100b functions as a slave.

The measurement device 100b includes a light emitting device 11, a MEMS mirror 12, a light receiving lens 13, a light receiving element 14, a main control unit 20, a reference clock generation unit 30, a synchronization control unit 40, a light emission signal generation unit 50, a laser light emitting unit 60, a drive signal generation unit 70, a flight time measurement unit 80, and the like. The measurement device 100a also has a configuration similar to the configuration of the measurement device 100b.

The light emitting device 11 is a device that emits laser light in accordance with an instruction from the laser light emitting unit 60 and includes a light emitting element such as a semiconductor laser. As an example, the light emitting device 11 emits pulsed light in a predetermined sampling cycle. The light emission signal generation unit 50 controls the laser light emitting unit 60. A timing at which the laser light emitting unit 60 instructs the light emitting device 11 to emit pulsed light is sent to the flight time measurement unit 80 from the light emission signal generation unit 50. This means that the flight time measurement unit 80 acquires the pulsed light emission timing.

The MEMS mirror 12 is a micro electro mechanical systems mirror and is a mirror that changes the angle of emitted laser light three-dimensionally. In the MEMS mirror 12, the angle of emitted laser light changes three-dimensionally in response to changes made in the rotation angle about a horizontal axis and the rotation angle about a vertical axis. The rotation angle about the horizontal axis is referred to as a horizontal angle H, and the rotation angle about the vertical axis is referred to as a vertical angle V. The drive signal generation unit 70 gives instructions on the horizontal angle H and the vertical angle V of the MEMS mirror 12. Pulsed light emitted from the light emitting device 11 is deflected according to the horizontal angle H and the vertical angle V of the MEMS mirror 12.

Pulsed light reflected by the MEMS mirror 12 is applied to a distance measurement target, scattered (reflected), and returned to the light receiving lens 13. This return light is collected by the light receiving lens 13 and received by the light receiving element 14.

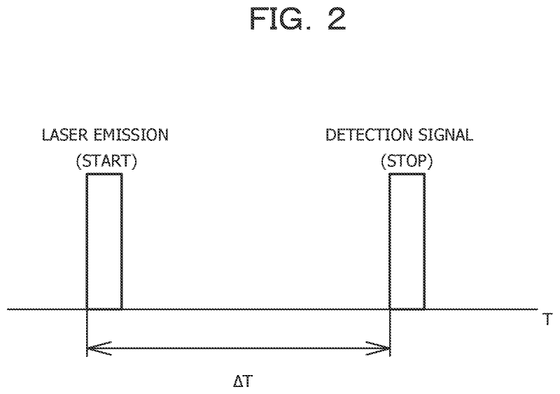

The flight time measurement unit 80 measures the distance to the distance measurement target by adopting a time-of-flight (TOF) technology. FIG. 2 is an explanatory diagram of the TOF technology. As illustrated in FIG. 2, the flight time measurement unit 80 measures a round-trip time (ΔT) from when the light emitting device 11 emits a laser pulse to when the return light returns from the distance measurement target, and calculates the distance to the distance measurement target by multiplying the measured round-trip time (ΔT) by the speed of light. Since the flight time measurement unit 80 is allowed to measure the distance every time the light emitting device 11 emits pulsed light, the distance may be measured in the sampling cycle.

The control device 200 transmits the frequency of a reference clock signal that defines the operation timing of the measurement devices 100a and 100b, to the measurement devices 100a and 100b. The frequency transmitted from the control device 200 is received by the main control unit 20.

The measurement device 100a sends a frame pulse (master frame pulse) and a line pulse (master line pulse) of the measurement device 100a to the inside and the outside of the measurement device 100a. The frame pulse and the line pulse will be described later.

The main control unit 20 sends the frequency received from the measurement device 100a to the reference clock generation unit 30. The reference clock generation unit 30 generates the reference clock signal at the received frequency. The reference clock signal generated by the reference clock generation unit 30 is sent to the synchronization control unit 40. In addition, the main control unit 20 sends the master line pulse and a correction maximum value to the synchronization control unit 40. Furthermore, the main control unit 20 sends the frame pulse (slave frame pulse) and the line pulse (slave line pulse) to the drive signal generation unit 70 and also sends the slave line pulse to the synchronization control unit 40.

The synchronization control unit 40 adjusts a clock signal according to the received master line pulse, slave line pulse, and correction maximum value and sends the adjusted clock signal to the light emission signal generation unit 50 and the drive signal generation unit 70. The operation timings of the light emission signal generation unit 50 and the drive signal generation unit 70 are defined according to the clock signal received from the synchronization control unit 40. Note that the frequency of the clock signal is set lower than the frequency of the reference clock signal.

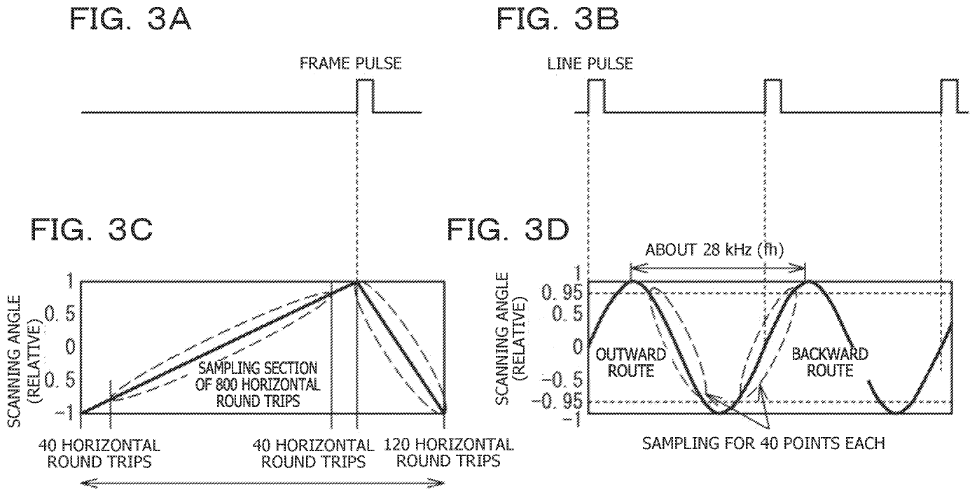

The MEMS mirror 12 scans the inside of a scanning range with the reflected light from the light emitting device 11 by driving on the two axes, namely, the vertical axis and the horizontal axis. FIG. 3A is a diagram illustrating the slave frame pulse (vertical drive timing signal) output by the main control unit 20. The frame pulse is a signal output by the MEMS mirror 12 at a scanning start timing for the scanning range. Therefore, the frame pulse is output every time the MEMS mirror 12 scans the scanning range once.

FIG. 3B is a diagram illustrating the slave line pulse (horizontal drive timing signal) output by the main control unit 20. The line pulse is a signal output by the MEMS mirror 12 at a scanning start timing for each line in the scanning range. Therefore, the line pulse is output every time the MEMS mirror 12 scans each line once. In the present embodiment, the scanning range contains 1000 lines. Therefore, the line pulse is output 1000 times in one cycle of the frame pulse.

FIG. 3C is a diagram illustrating a vertical drive signal generated by the drive signal generation unit 70 according to the timing of the frame pulse. In FIG. 3C, the lateral axis represents time, and the longitudinal axis represents a relative scanning angle in the vertical direction. The label “−1” on the longitudinal axis represents the smallest scanning angle in the vertical direction. The label “1” on the longitudinal axis represents the largest scanning angle in the vertical direction. When this relative scanning angle in the vertical direction makes a round trip between “−1” and “1”, the scanning angle in the vertical direction makes a round trip once. Each angle obtained by dividing the relative scanning angle in the vertical direction into 1000 corresponds to each line.

One round trip of the scanning angle in the vertical direction is completed from the timing of the frame pulse illustrated in FIG. 3A to the timing of the subsequent frame pulse. In the present embodiment, as an example, the scanning angle in the vertical direction changes linearly from “−1” to “1” while the round trip in a horizontal direction is performed 880 times. Thereafter, the scanning angle in the vertical direction changes linearly from “1” to “−1” while the round trip in the horizontal direction is performed 120 times. In this manner, while the round trip in the horizontal direction is performed 1000 times, the round trip in the vertical direction is performed once. The frequency at which the round trip in the vertical direction is repeated is about 28 Hz, and the frequency at which the round trip in the horizontal direction is repeated is about 28 kHz.

FIG. 3D is a diagram illustrating a horizontal drive signal generated by the drive signal generation unit 70 according to the timing of the line pulse. In FIG. 3D, the lateral axis represents time, and the longitudinal axis represents a relative scanning angle in the horizontal direction. The label “−1” on the longitudinal axis represents the smallest scanning angle in the horizontal direction. The label “1” on the longitudinal axis represents the largest scanning angle in the horizontal direction. When this relative scanning angle in the horizontal direction makes a round trip between “−1” and “1”, the scanning angle in the horizontal direction makes a round trip once. The horizontal drive signal forms a sine wave.

One round trip of the scanning angle in the horizontal direction is completed from the timing of the line pulse illustrated in FIG. 3B to the timing of the subsequent line pulse. In the present embodiment, as an example, 40 points are sampled (distance is measured) on an outward route from “0.95” to “−0.95”, and 40 points are sampled (distance is measured) on a subsequent backward route from “−0.95” to “0.95”. The sampling interval is 320 ns as an example.

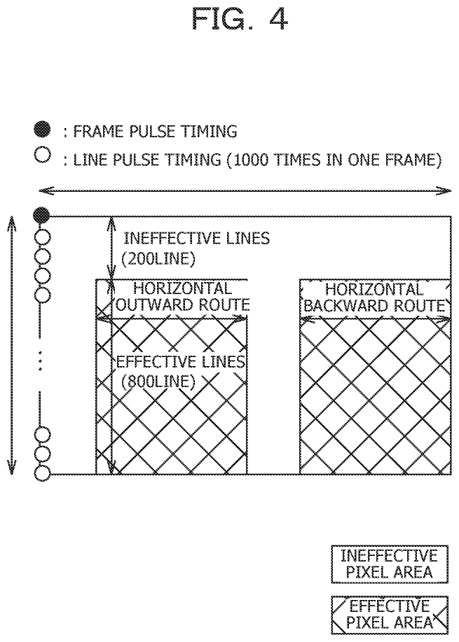

FIG. 4 is a diagram illustrating a relationship between an ineffective pixel area and an effective pixel area during such one round trip in the vertical direction. The example in FIG. 4 represents raster scanning specifications. The effective pixel area is an area where sampling is performed. The ineffective pixel area is an area where sampling is not performed. As illustrated in FIG. 4, 200 lines are given as ineffective lines and 800 lines are given as effective lines. In addition, a part of a horizontal outward route is given as an effective pixel area, and a part of a horizontal backward route is given as an effective pixel area.

The MEMS mirror 12 normally utilizes resonance for at least one axis among the two axes, namely, the horizontal axis and the vertical axis, in order to increase the scanning speed and also to increase the drive angle. In the present embodiment, resonance is utilized normally in the horizontal direction where the number of round trips is larger. An individual difference is sometimes produced in the resonance frequency due to variations during manufacturing. Therefore, for example, when raster scanning is performed horizontally with resonance and vertically without resonance, there is a possibility that the scanning speed in the horizontal direction differs and the frame rate differs for each individual. A large jitter that occurs by forcibly aligning the MEMS mirror 12 with different resonance frequencies into the reference frequency puts a load on the MEMS mirror 12 and, at the same time, can be a factor that causes lack of stability in a system that involves delicate control on the order of nanoseconds. A high-precision mechanism for synchronizing the phases of drive signals between a plurality of measurement devices with different resonance frequencies of the MEMS mirrors 12 while minimizing jitters is expected.

Thus, the present embodiment has a configuration that corrects the displacement between resonance points caused by the individual differences of the MEMS mirrors 12 between a plurality of measurement devices and causes the plurality of measurement devices to operate synchronously.

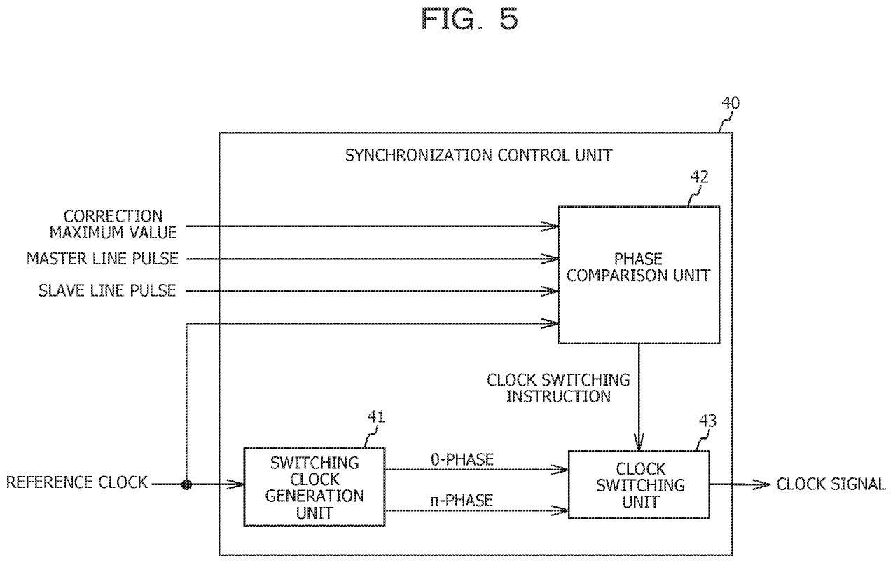

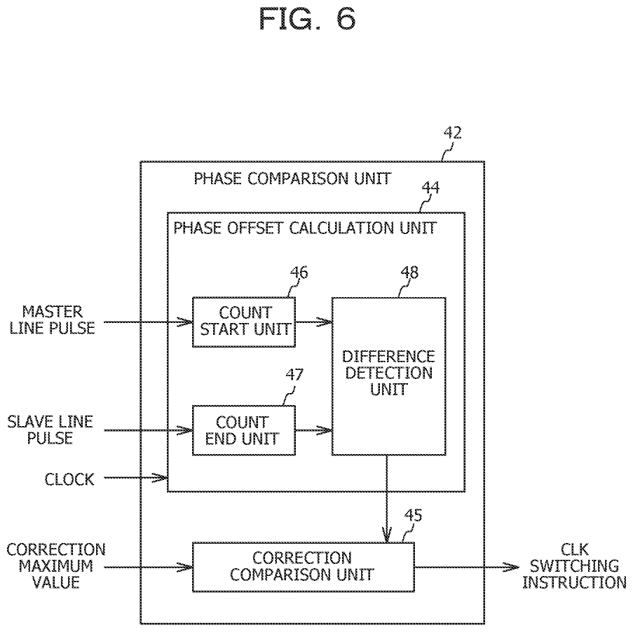

FIG. 5 is a block diagram illustrating details of the synchronization control unit 40. As illustrated in FIG. 5, the synchronization control unit 40 includes a switching clock generation unit 41, a phase comparison unit 42, and a clock switching unit 43. FIG. 6 is a block diagram illustrating details of the phase comparison unit 42. As illustrated in FIG. 6, the phase comparison unit 42 includes a phase offset calculation unit 44 and a correction comparison unit 45. The phase offset calculation unit 44 includes a count start unit 46, a count end unit 47, and a difference detection unit 48.

The master line pulse is sent to the count start unit 46. The slave line pulse is sent to the count end unit 47. The correction maximum value is sent to the correction comparison unit 45. The reference clock signal defines the operation timings of the switching clock generation unit 41 and the phase offset calculation unit 44.

The switching clock generation unit 41 generates a switching clock for making phase adjustments (addition and removal of pulses of the reference clock signal) on the clock signal, from the reference clock signal.

The count start unit 46 starts counting at the rise timing of the master line pulse. The count end unit 47 ends counting at the rise timing of the slave line pulse. The difference detection unit 48 detects the phase difference between the master line pulse and the slave line pulse, using the count start of the count start unit 46 and the count end of the count end unit 47.

The correction comparison unit 45 outputs a clock switching signal generated by referring to the phase difference detected by the difference detection unit 48 and the correction maximum value, to the clock switching unit 43. The correction comparison unit 45 determines whether or not the phase difference detected by the difference detection unit 48 exceeds the correction maximum value. When it is determined that the correction maximum value is exceeded, the correction comparison unit 45 replaces the phase difference with the correction maximum value. The correction maximum value can be set optionally by the control device 200.

The clock switching unit 43 adds and removes phases of the clock signal by switching the switching clock between a 0-phase and a n-phase, depending on the clock switching signal received from the phase comparison unit 42. This generates an adjusted clock signal.

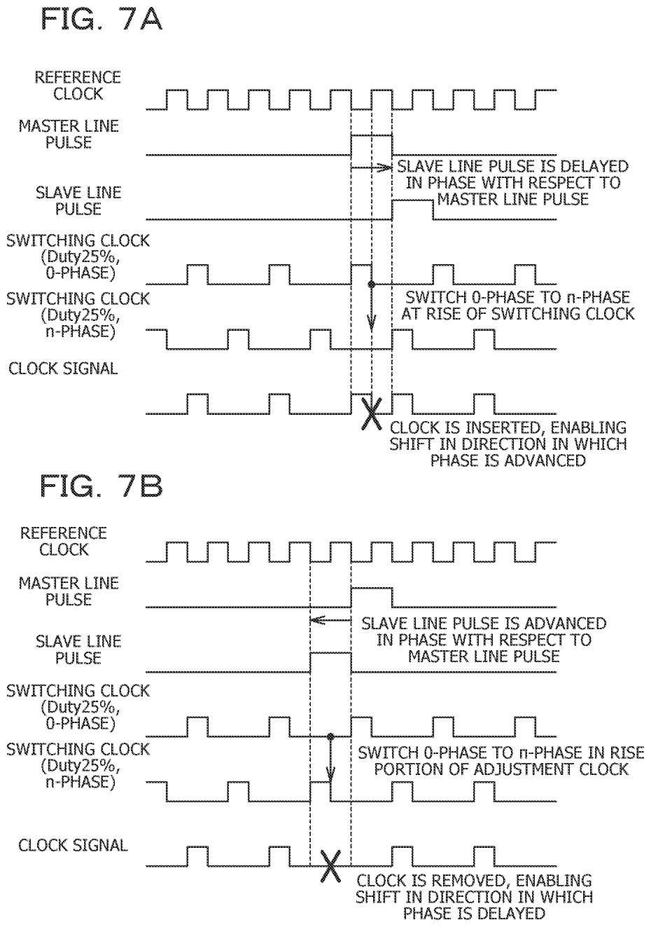

FIGS. 7A and 7B are diagrams illustrating details of the clock signal adjustments by the synchronization control unit 40. FIG. 7A is a diagram illustrating a case where the slave line pulse is delayed in phase with respect to the master line pulse. FIG. 7B is a diagram illustrating a case where the slave line pulse is advanced in phase with respect to the master line pulse.

In the example in FIG. 7A, a part of the clock signal is removed, and the phase is shifted in a direction in which the phase is delayed. In the example in FIG. 7B, a clock is inserted into the clock signal, and the phase is shifted in a direction in which the phase is advanced.

In this manner, to adjust the phase difference between two signals, by switching the clock signal between the 0-phase and n-phase to add or remove the pulse of the reference clock signal, adjustments at fine resolution according to the clock signal speed is enabled. This enables to optionally set the adjustment maximum value. As a result, the load put on the MEMS mirror 12 during phase correction may be reduced, and the jitter characteristics may be improved in association with the phase correction, which may decrease the phase difference between two signals.

Note that, in the present embodiment, a correction table or the like does not have to be prepared. Therefore, high resolution may be achieved over a wide scanning range without preparing an enormous correction table. In addition, since the correction of minute fluctuations caused by OSC deviation and the like is not intended, the followability between measurement devices is enhanced. Furthermore, by optionally setting the correction maximum value for large fluctuations (phase displacement), excessive correction is restrained, and enhanced followability may be achieved while damage to the MEMS mirror 12 is suppressed.

As described above, according to the present embodiment, measurement devices may be easily synchronized with each other.

Note that, in the examples in FIGS. 7A and 7B, the line pulse timings are matched between the plurality of measurement devices, but the present embodiments are not restricted to this. The phase difference between the master line pulse and the slave line pulse may be adjusted such that the timing difference between the line pulses of the plurality of measurement devices becomes a defined value.

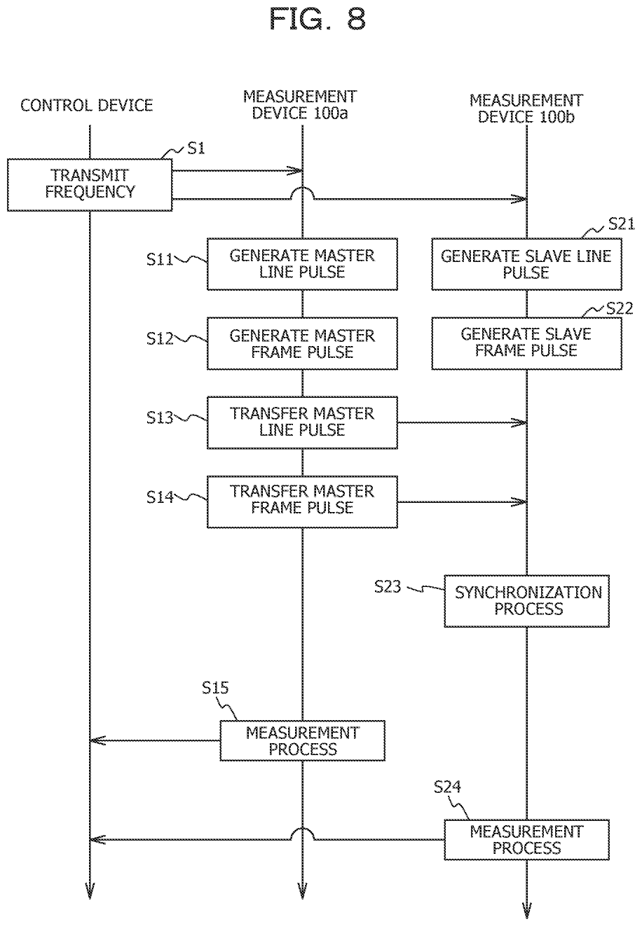

FIG. 8 is a flowchart representing an example of the operation of the measurement system 300. As illustrated in FIG. 8, the control device 200 transmits the frequency to the measurement devices 100a and 100b (step S1).

The main control unit 20 of the measurement device 100a uses the reference clock signal at the frequency received from the control device 200 to generate the master line pulse (step S11) and to generate the master frame pulse (step S12). The main control unit 20 of the measurement device 100a transfers the master line pulse to the measurement device 100b (step S13) and transfers the master frame pulse to the measurement device 100b (step S14). Thereafter, in the measurement device 100a, the laser light emitting unit 60 emits pulsed light in the sampling cycle, and the drive signal generation unit 70 generates the drive signal according to the master frame pulse and the master line pulse to control the MEMS mirror 12. The flight time measurement unit 80 measures the distance in the sampling cycle (step S15).

The main control unit 20 of the measurement device 100b uses the reference clock signal at the frequency received from the control device 200 to generate the slave line pulse (step S21) and to generate the slave frame pulse (step S22). Next, the synchronization control unit 40 performs a synchronization process (step S23).

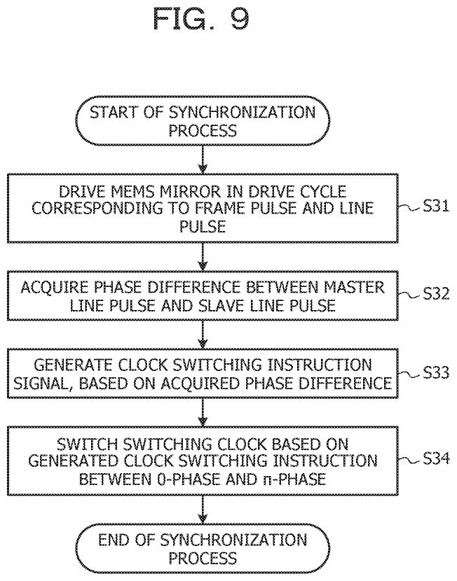

FIG. 9 is a flowchart representing an example of the synchronization process in step S23. As illustrated in FIG. 9, the drive signal generation unit 70 drives the MEMS mirror 12 in a drive cycle corresponding to the slave frame pulse and the slave line pulse (step S31). Next, the phase comparison unit 42 acquires the phase difference between the master line pulse and the slave line pulse (step S32). Next, the correction comparison unit 45 generates a clock switching instruction signal, based on the acquired phase difference (step S33). Next, the clock switching unit 43 switches a switching internal clock between the 0-phase and the n-phase, based on the clock switching instruction (step S34). The synchronization process is completed by above steps S31 to S34.

Thereafter, in the measurement device 100b, the laser light emitting unit 60 emits pulsed light in the sampling cycle, and the drive signal generation unit 70 generates the drive signal according to the master frame pulse and the master line pulse to control the MEMS mirror 12. The flight time measurement unit 80 measures the distance in the sampling cycle (step S24).

Although the synchronization between the measurement devices 100a and 100b has been described in the above embodiment, the number of devices to be synchronized may be three or larger. For example, in addition to the measurement devices 100a and 100b, a measurement device 100c having a configuration similar to the configuration of the measurement devices 100a and 100b may be included. For example, the measurement device 100a functioning as a master may transfer the master line pulse and the master frame pulse to the measurement devices 100b and 100c functioning as slaves.

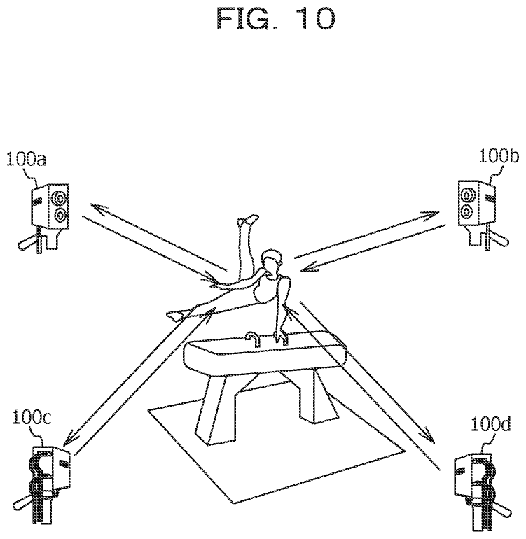

FIG. 10 is a diagram illustrating an application example of the measurement system 300. As illustrated in FIG. 10, a plurality of measurement devices 100a to 100d is installed. These measurement devices 100a to 100d are installed so as to surround a measurement target (a gymnastics athlete in the example in FIG. 10). There is a possibility that some parts of the athlete's own body or equipment causes shadows, which produces a portion of the athlete's body for which 3D data may not be acquired. Thus, the measurement devices 100a to 100d are installed so as to sandwich the athlete from the front and back of the athlete. This allows the measurement of detailed 3D data of the athlete. By facing each other in this manner, it becomes easier for the interference to come about. Accordingly, the interference may be avoided using the synchronization technique as in the above embodiment.

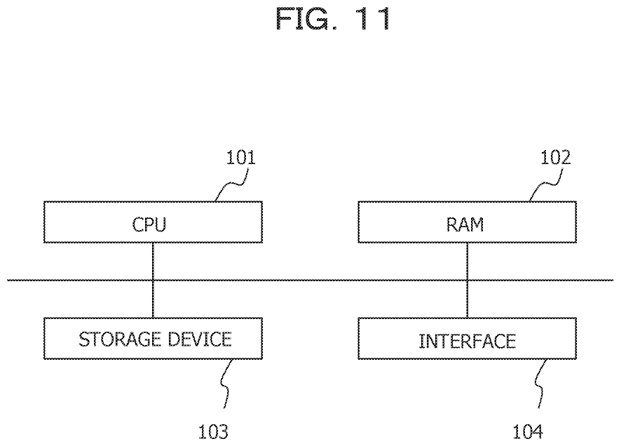

FIG. 11 is a block diagram for explaining hardware configurations of the main control unit 20, the reference clock generation unit 30, the synchronization control unit 40, the light emission signal generation unit 50, the laser light emitting unit 60, the drive signal generation unit 70, and the flight time measurement unit 80. As illustrated in FIG. 11, each of these units is implemented by a central processing unit (CPU) 101, a random access memory (RAM) 102, a storage device 103, an interface 104, and the like. These components are connected to each other by a bus or the like. The central processing unit (CPU) 101 is a central arithmetic processing device. The CPU 101 includes one or more cores. The random access memory (RAM) 102 is a volatile memory that temporarily stores a program to be executed by the CPU 101, data to be processed by the CPU 101, and the like. The storage device 103 is a nonvolatile storage device. For example, a read only memory (ROM), a solid state drive (SSD) such as a flash memory, a hard disk to be driven by a hard disk drive, or the like may be used as the storage device 103. When the CPU 101 executes a program stored in the storage device 103, the main control unit 20, the reference clock generation unit 30, the synchronization control unit 40, the light emission signal generation unit 50, the laser light emitting unit 60, the drive signal generation unit 70, and the flight time measurement unit 80 are implemented. Note that the main control unit 20, the reference clock generation unit 30, the synchronization control unit 40, the light emission signal generation unit 50, the laser light emitting unit 60, the drive signal generation unit 70, and the flight time measurement unit 80 may be implemented by an integrated circuit such as an application specific integrated circuit (ASIC) or a field programmable gate array (FPGA). For example, the synchronization control unit 40, the light emission signal generation unit 50, and the drive signal generation unit 70 may be implemented by the FPGA. Alternatively, the main control unit 20, the reference clock generation unit 30, the synchronization control unit 40, the light emission signal generation unit 50, the laser light emitting unit 60, the drive signal generation unit 70, and the flight time measurement unit 80 may be dedicated circuits or the like.

In each of the above examples, the drive signal generation unit 70 is an example of a drive signal generation unit that generates a drive signal with a sine wave, according to a clock signal. The MEMS mirror 12 is an example of a MEMS mirror that controls a reflection direction of output light of a light emitting device, by utilizing a resonance frequency, according to the drive signal. The main control unit 20 is an example of a control unit that generates a control signal that controls a timing at which the drive signal generation unit generates the drive signal. The slave line pulse is an example of a control signal. The master line pulse is an example of a desired control signal. The synchronization control unit 40 is an example of a clock signal adjustment unit that adjusts the clock signal by adding or removing a pulse of a reference clock signal, according to a phase difference between the desired control signal and the control signal. The phase comparison unit 42 is an example of an instruction generation unit that generates a clock switching instruction from the phase difference. The switching clock generation unit 41 is an example of a switching clock generation unit that generates a switching clock for adjustment, according to the reference clock signal. The clock switching unit 43 is an example of a clock switching unit that switches a clock of the clock signal, by using the switching clock, according to the clock switching instruction.

While the embodiments have been described above in detail, the embodiments are not limited to such specific embodiments, and various modifications and alterations may be made within the scope of the embodiments described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A measurement device comprising:
a memory; and
a processor coupled to the memory and configured to:
generate a drive signal with a sine wave, according to a clock signal;
control a reflection direction of output light of a light emitting device, by utilizing a resonance frequency, according to the drive signal;
control a timing at which the drive signal is generated; and
add or remove a pulse of a reference clock signal configured to generate the clock signal, according to a phase difference between a desired control signal and the control signal.

2. The measurement device according to claim 1, wherein the desired control signal is a signal that controls the timing at which another measurement device generates the drive signal configured to drive the MEMS mirror included in the another measurement device.

3. The measurement device according to claim 1, wherein the processor:
generates a clock switching instruction from the phase difference;
generates a switching clock for adjustment, according to the reference clock signal; and
switches a clock of the clock signal, by using the switching clock, according to the clock switching instruction.

4. The measurement device according to claim 1, wherein a maximum value is designated for a clock adjustment amount.

5. A measurement method comprising:
generating a drive signal with a sine wave, according to a clock signal;
controlling a reflection direction of output light of a light emitting device, by utilizing a resonance frequency, according to the drive signal;
controlling a timing at which the drive signal is generated; and
adding or removing a pulse of a reference clock signal configured to generate the clock signal, according to a phase difference between a desired control signal and the control signal.

6. The measurement method according to claim 5, wherein the desired control signal is a signal that controls the timing at which another measurement device generates the drive signal configured to drive the MEMS mirror included in the another measurement device.

7. The measurement method according to claim 5, further comprising:
generating a clock switching instruction from the phase difference;
generating a switching clock for adjustment, according to the reference clock signal; and
switching a clock of the clock signal, by using the switching clock, according to the clock switching instruction.

8. The measurement method according to claim 5, wherein a maximum value is designated for a clock adjustment amount.

9. A non-transitory computer-readable recording medium storing a measurement program causing a computer to execute a processing, the processing comprising:
generating a drive signal with a sine wave, according to a clock signal;
controlling a reflection direction of output light of a light emitting device, by utilizing a resonance frequency, according to the drive signal;
controlling a timing at which the drive signal is generated; and
adding or removing a pulse of a reference clock signal configured to generate the clock signal, according to a phase difference between a desired control signal and the control signal.

10. The non-transitory computer-readable recording medium according to claim 9, wherein the desired control signal is a signal that controls the timing at which another measurement device generates the drive signal configured to drive the MEMS mirror included in the another measurement device.

11. The non-transitory computer-readable recording medium according to claim 9, further comprising:
generating a clock switching instruction from the phase difference;
generating a switching clock for adjustment, according to the reference clock signal; and
switching a clock of the clock signal, by using the switching clock, according to the clock switching instruction.

12. The non-transitory computer-readable recording medium according to claim 9, wherein a maximum value is designated for a clock adjustment amount.
